(19) United States
(12) Patent Application Publication
(10) Pub. No.: US 2023/0348113 A1
(43) Pub. Date: Nov. 2, 2023

(54) RECOVERY OF ESCAPED OXYGEN FROM EARTH USING CYCLOTRON SYTEMS FOR THE CREATION OF ENERGY, WATER, AND A BREATHABLE ATMOSPHERE ON MARS, THE MOON, OR INNER PLANETS

(71) Applicant: Kenneth Michael Beck, Evanston, IL (US)

(72) Inventor: Kenneth Michael Beck, Evanston, IL (US)

(21) Appl. No.: 17/734,081

(22) Filed: May 1, 2022

(51) Int. Cl. B64G 1/10; F17C 3/08; H05H 13/00

(52) U.S. Cl. CPC B64G 1/105; F17C 3/08; H05H 13/005; B64G 2001/1064; B64G 2001/1092

(57) ABSTRACT

NASA, ESA, and Japanese Space Agency (JAXA) have undertaken studies (e.g., “Lunar Ice-Trap ISRU Mining, Processing and Storage Infrastructure: An infrastructure that mines and breaks down lunar ice into oxygen and hydrogen fuel”) to determine likely sources of water and oxygen for human colonies on Mars or Moon. Some of these studies are university-level research through fund allocations for departmental research, or through student interest in space exploration. Other studies are conducted at national levels through space agencies and through privately funded space probes. One of these studies was executed by the JAXA determined the source of the lunar-ice on the Moon (from the Kaguya/ZELENE lunar probe). JAXA estimated that 90 metric tons of Earth's atmosphere escapes per day with oxygen ions reaching energies of between 1 keV and 10 keV.

### CROSS-REFERENCE(S) TO RELATED APPLICATION(S) OR PATENT(S)

This application claims the benefit of U.S. Provisional Application No. 63/273,859, entitled “RECOVERY OF ESCAPED OXYGEN FROM EARTH AND MARS WITH SOLAR WIND-GENERATED PROTONS, HYDROGEN, AND HELIUM FOR THE CREATION OF ENERGY, WATER, AND A BREATHABLE ATMOSPHERE ON INNER PLANETS OR MOONS” filed on Oct. 29, 2021, which is hereby incorporated by reference in its entirety and corrected here. Additionally, U.S. Pat. No. 1,948,384 is for the cyclotron, invented by Prof. Dr. Ernest Lawrence now held by Research Corporation, is admitted as prior art.

### BACKGROUND

NASA, ESA, and Japanese Space Agency (JAXA) have undertaken studies (e.g., “Lunar Ice-Trap ISRU Mining, Processing and Storage Infrastructure: An infrastructure that mines and breaks down lunar ice into oxygen and hydrogen fuel”) to determine likely sources of water and oxygen for human colonies on Mars or Moon. Some of these studies are university-level research through fund allocations for departmental research, or through student interest in space exploration. Other studies are conducted at national levels through space agencies and through privately funded space probes. One of these studies was executed by the JAXA determined the source of the lunar-ice on the Moon (from the Kaguya/ZELENE lunar probe). JAXA estimated that 90 metric tons of Earth's atmosphere escapes per day with oxygen ions reaching energies of between 1 keV and 10 keV.

Based on the above research, I propose generating breathable and available oxygen and drinkable water for proposed Martian habitats or the Moon Artemis habitat, among others. I have estimated a minimal use of water by humans in a dry, high altitude desert with labor-intensive exercise is about 3-4 gallons (32 pounds) per human per day for cleaning, drinking and hydrating and growing crops, based on a study undertaken by myself over 15 years in high altitude survival and emergency care. An additional need for oxygen in breathing, and running equipment is about 5-8 gallons (64 pounds). Therefore, totally about 96 pounds of oxygen may be needed per human per day.

Some researchers recommend melting the ice that is naturally present on Mars to generate drinkable water, and then further breaking the water into hydrogen and oxygen to generate breathable atmosphere. However, this proposed technology requires vast amounts of energy to melt the discovered ice, eliminate the brine within it, and reconstitute the water in a drinkable and pure form. Additional energy is needed to break the water into hydrogen and oxygen for fuel and a breathable atmosphere. Accordingly, there remains a need for methods and systems for efficient production of oxygen and water for use on Mars, the Moon and/or other inner planets and moons. I estimated that over a ten-year period, we will save any ‘Mars and Moon Command and Colonization’ over USD 32 million per launch cycle (2021 estimate).

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

FIG. 1 shows Earth 20 having magnetic field 40. Solar wind 15 coming off the Sun 10 sweeps some amount of Earth atmosphere away from Sun, toward Moon 30. The atmosphere is either driven off by thermal energy to meet or exceed the escape velocity from Earth's gravitation field, or the atmosphere may be driven through ionization processes initiated by the solar wind 15. Then, as charged particles, this aspect of the atmosphere (mostly biogenic oxygen, as nitrogen ions quickly recombine to neutral gas) is swept up into Earth's magnetic field into plasma sheets and further into space, towards the Moon 30.

FIG. 2 is a schematic view of a trajectory 60 of a charged particle 50 in a magnetic field 40. In general, the ionized oxygen 50 behaves as a charged particle in presence of magnetic field. The new finding in this study is the presence of higher-energy O⁺ ions (1-10 keV) during almost the entire period of the plasma sheet encounter with the Moon, which were not detected when the Moon was outside the magnetosphere. The energy distributions of H⁺, the solar wind component, and O⁺ before, during and after the plasma sheet encounter, clearly illustrating the enhancement of high-energy O⁺ (1-10 keV) ions during plasma sheet encounters in comparison with those in the lobe. The calculated density and net flux of the magnetospheric O⁺ during the plasma sheet encounter were 1.2×10⁻³ cm⁻³ and 2.6×10⁴ cm⁻² s⁻¹, respectively, which are consistent with the previous observations of 2.1×10⁴ ions cm⁻² s⁻¹ at approximately 75-150R_{E}, where R_{E} is the Earth radius (for the flux calculation).

### BRIEF DESCRIPTION OF THE DRAWINGS

The aspects of the present disclosure can be better understood with reference to the following drawings. The components in the drawings are not necessarily to scale. Instead, emphasis is placed on clearly illustrating the principles of the present disclosure.

FIG. 1 is a schematic view of Earth's magnetic field.

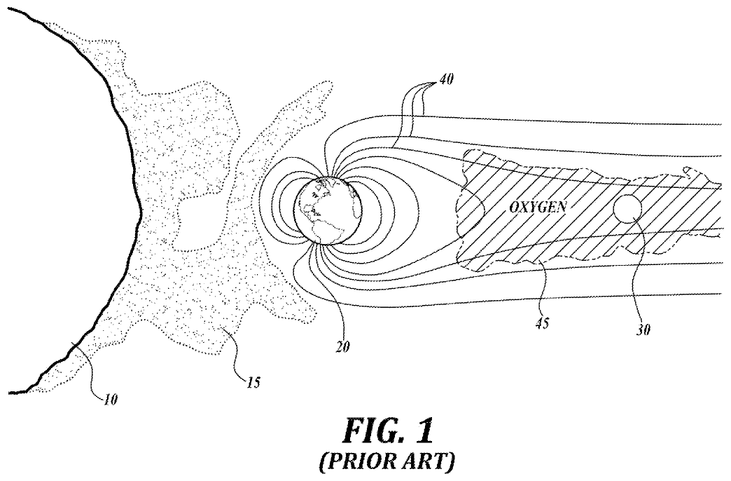

FIG. 2 is a schematic view of a trajectory of a charged particle in a magnetic field.

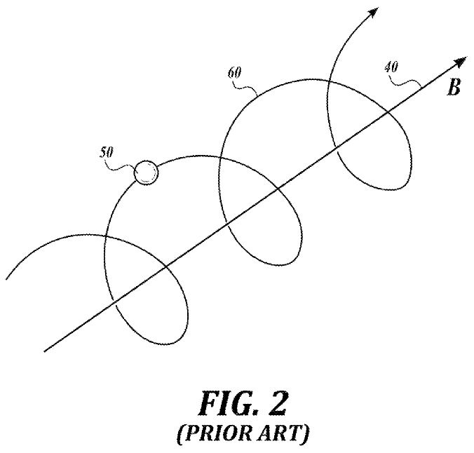

FIG. 3 is a partially schematic view of a cyclotron according to prior art.

FIG. 4 is a partially schematic view of an apparatus for oxygen recovery in accordance with an embodiment of the presently disclosed technology.

FIG. 5 is a top/side view of the apparatus for oxygen recovery in accordance with an embodiment of the presently disclosed technology.

FIG. 5A is an isometric view of an apparatus for oxygen recovery in accordance with an embodiment of the presently disclosed technology.

### DETAIL DESCRIPTION

The inventive technology includes devices and methods for recovery of oxygen and/or other gases. It is known that constituents of Earth's upper atmosphere reach escape velocity in the upper atmosphere due to, for example, solar wind. In general, gasses in the upper atmosphere of Earth can be relatively easily induced to leave with little expense of energy, as the mean free path for escape is over a meter.

This oxygen may be harvested by cyclotrons positioned, in some embodiments in Earth's ultra high atmosphere away from Sun; in other embodiments between Earth and Moon; or finally in further embodiments where the cyclotrons are positioned antipodal to the Earth on the opposite side of the Moon and in the foci of the magnetic field or magnetosphere of the Earth. The oxygen can be captured in inflatable, or solid dewars. In some embodiments, after recovery of the oxygen, the captured oxygen can be stored as either liquid or gas in orbit around Earth, and then transported from Earth orbit to the Moon orbit or Mars orbit to be utilized by inhabitants at will. Since the oxygen is harvested in orbit around Earth, the transportation requires relatively little energy. ‘Solar sails’ and the oxygen dewars can supply their transportation fuels, in fact.

When needed, orbiting reservoirs of liquid oxygen and liquid hydrogen can—in a controlled fashion—be combined. The chemical reactions of oxygen and hydrogen are exothermic, releasing vast amounts of energy as they combine. They are the opposite of hydrolysis, which uses energy.

The combination of oxygen and hydrogen will provides energy for the reaction as well as excess energy that can be utilized for the work of space exploration, or the sustenance of human life, or to drive the cyclotrons' radio frequency generators and secondary magnetic fields (e.g., for conversion to energy, water, of hydrogen and oxygen fuels for rockets, navigational apparatus, colonies, and for Martian or Lunar vehicles or space probes). The average abundance ratio of O⁺/H⁺ was 2.4% which yields sufficient partial pressures of hydrogen ions for production of water on combination and provide the requirements of life in habitats as stated previously.

As explained, 90 metric tons of Earth's atmosphere escapes daily. With some embodiments of the inventive technology, it may be possible to recover up to 5,000 kg of pure oxygen in a usable form for the creation of water and energy including fuels with the reasonably sized apparatus. This amount of oxygen may initially support 100 human space explorers, indefinitely. Once established on the Moon or Mars, habitats may recycle oxygen/water more effectively. At the same time, as the oxygen capture in Earth's orbit increases, the habitat that can be supported by the inventive technology may reach 10,000 humans, or more.

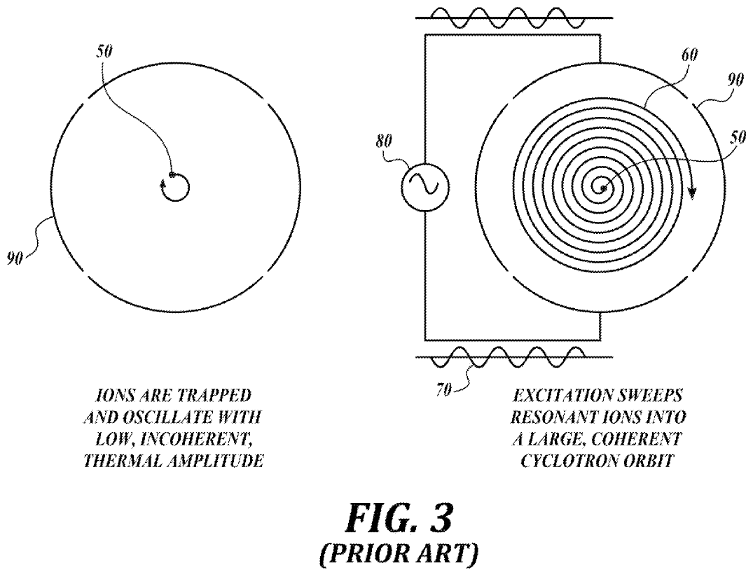

FIG. 3 is a partially schematic view of a cyclotron 90 in accordance with the prior art. Charged particles 50 can be driven into a spiral trajectory 60 using suitable source of variable voltage 80 that, in turn, produces variable RF field in the cyclotron 90.

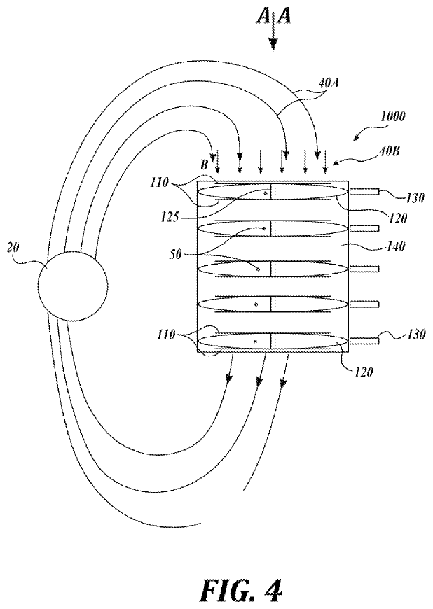

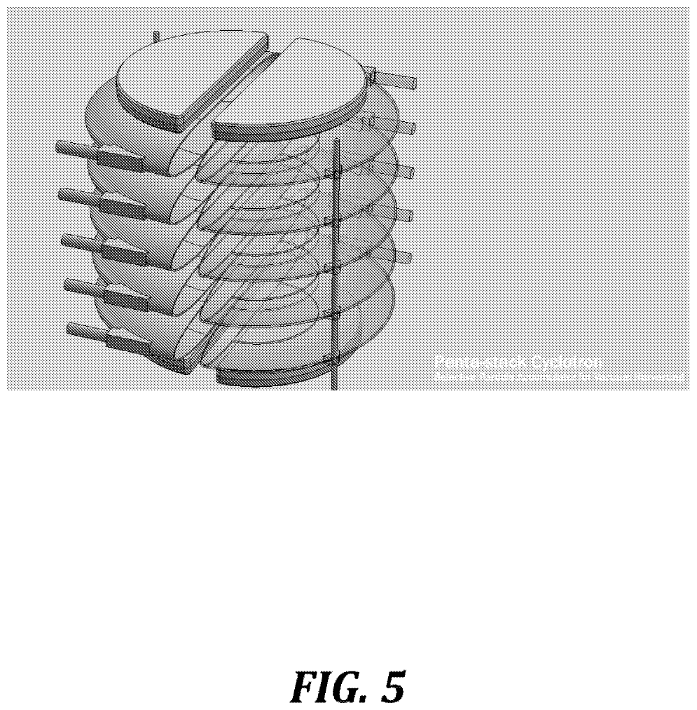

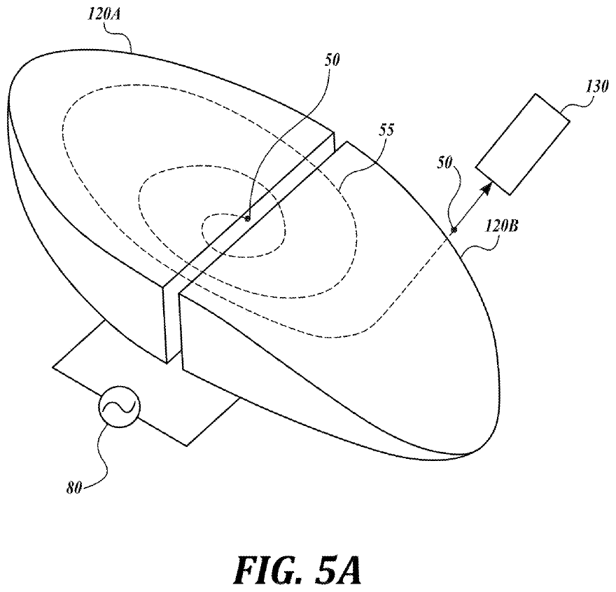

FIG. 4 is a partially schematic side view of a “penta-stack” apparatus 1000 for oxygen recovery in accordance with an embodiment of the presently disclosed technology. The apparatus 1000 includes several cyclotrons 120. The cyclotrons 120 may also be referred to as space-based ion cyclotron mass Resonance (S-BICMRD) devices. The individual cyclotrons 120 can be held together by a structure 140, e.g., an aerogel or other dielectric encapsulate, light structural beams, etc. The cyclotrons 120 are subjected to a changing (e.g., rotating) radio frequency (RF) field, as explained in more detail with respect to FIG. 5 below.

As the charged oxygen ions 50 enter the cyclotrons 120, the ions 50 are subjected to Earth's magnetic field 40A and a magnetic field 40B from permanent magnets or electromagnets 110, in addition to a rotating RF field of the cyclotron 120. As a result, the charged oxygen ions 50 rotate in a spiral motion within the cyclotrons 120, and eventually exit the cyclotrons 120 to be captured by the dewars 130.

In some embodiments, the thickness of the material of the individual cyclotrons 125 can be relatively thin (e.g., several nanometers), enough to reduce the energy of the oxygen ions by, for example, 2 keV (e.g., 1 keV lost through each metal surface of the cyclotron 120 that the oxygen ion 50 penetrates through). As a result, the oxygen ions with lower energy content (e.g., less than 2 keV) remain trapped in the first cyclotron 120, while the oxygen ions with higher energy content proceed toward the remaining cyclotrons 120. Next, the oxygen ions within the energy band 2-4 keV are trapped in the second cyclotron 120, and so on. As a result, about five cyclotrons 120 may capture most of the oxygen ions 50 that have energy bandwidth of about 1-10 keV. In other embodiments, other ranges of metal thickness, number of cyclotrons 120, and energy bandwidth are also possible. In some embodiments, the cyclotrons 120 and/or the structure 120 may be 3D-printable in space.

In some embodiments, charged oxygen atoms (O⁺) 50, are separated by their unique cyclotron angular frequency in the cyclotrons 120, and then neutralized and concentrated for transport to Mars or Moon. In some embodiments, uncharged oxygen is routed to electron filaments (not shown) to be ionized, and then routed to the cyclotrons and concentrated based on their cyclotron frequency. In some embodiments, the oxygen can be concentrated as a liquid in cryo-dewars 130 for transport. In some embodiments, the oxygen can be converted immediately to water in space using the hydrogen and protons in the solar wind.

In some embodiments, the residual nitrogen ions (N⁺) can also be captured separately that escape Earth's atmosphere and be transported to Mars or The Moon the generate ammonia (NH₃) the first stage and necessary component in creating agricultural fertilizer. Although the amount of nitrogen is limited by chemical physics processes in the upper atmosphere of Earth. Ammonia is also a by-product of human urine and may be acquired in a different manner.

In some embodiments, the cyclotron 120 includes two halves 120A/120B that are electrically connected with a source of alternating voltage 80.

The oxygen ion 50 in a static and uniform magnetic field moves in a circle due to the Lorentz force. The cyclotron angular frequency is given by:

ω=2πf [1]

It can be shown through the period of circulation, that the frequency of the circulation, f, of the particle in the magnetic field has to be equal to the radio frequency of the electric source, f_{z}:

f=f_{z}=eB/2mπ [2]

where e=1.602*10⁻¹⁹ coloumbs (a constant of physics), m is the non-relativistic mass of the charged particle, and B is the magnetic field.

However, with the radio frequency field caused by, for example, an alternating current or a radio frequency voltage source 80, the charged particle (e.g., oxygen ion 50) moves in a helical spiral 50. That is, the circular motion may be superimposed with a uniform axial motion, resulting in a helix with a uniform motion orthogonal to the field, e.g., in the presence of an electrical field, resulting in the helical spiral (cycloid) 55. It is this helical motion that allows oxygen to exit the cyclotron. The oxygen ions that exit the cyclotron 120, can be collected by the dewar 130, and concentrated for transport.

In some embodiments, the radial size and thickness of the cyclotron 120 is determined by the strength of Earth's magnetic field, the nascent magnetosphere, and in some embodiments by a combination of both this nascent field and an artificial magnetic field employed through the use of rare earth magnets attached to the cyclotron apparatus (e.g., magnetic fields 40A and 40B) employed and the energy of the oxygen ions 50 entering the cyclotron 120.

It can be shown that:

Rₘₐₓ=[2m*Eₘₐₓ]^{1/2}/eB

Rₘₐₓ=[2(15.99amu*1.660⁻²⁷kg/amu)(10keV)]^{1/2}/(1.602*10⁻¹⁹C)*B. [3]

Based on the equations [1]-[3] above, if Earth magnetic field 40A is used (B=0.00005 T for Earth's nascent magnetic field at 400-1,000 km above the planet surface), an Rₘₐₓ ˜1,150 meters is needed for 10 keV O⁺ ions.

However, with the addition of small, rare earth magnets (magnetic field 40B) having a magnetic field strength of 0.005 T (equivalent to the strength of a small household refrigerator magnet), Rₘₐₓ becomes ˜11.5 meters for the oxygen ions of up to 10 keV. In general, small radial size is not necessarily needed because the larger the cyclotron diameter, the more oxygen ions may be trapped. This may be optimized for maximal capture of ions versus size and ability to control the device.

FIG. 5 is a top/side view of a working 5-stage or penta-stack apparatus for oxygen recovery as sketched schematically in FIG. 4, in accordance with an embodiment of the presently disclosed technology. The horizontal tubes or nozzles 130 represent final product extraction attachments for cryo-dewars. Small, flat rare earth magnets are on top and bottom of the penta-stack.

FIG. 5A is an isometric view of an apparatus for oxygen recovery in accordance with an embodiment of the presently disclosed technology. In some embodiments, the cyclotron 120 includes two halves 120A/120B that are electrically connected with a source of alternating voltage 80.

The illustrated cyclotron 120A/120B is thicker in the middle, and narrower at the periphery, but other shapes of the cyclotron are also possible. For example, the cyclotron 120 may have uniform thickness. In some embodiments, additional dewars 130 may be used to capture other gases (e.g., nitrogen) at different location of the cyclotron 120.

1. An apparatus for capturing gases from Earth atmosphere, comprising:
at least one cyclotron; a source of a radio frequency field;
a dewar for capturing gases,
wherein the apparatus is configured to orbit around Earth.

2. The apparatus of claim 1, wherein the source of RF field is a voltage source of alternating current.

3. The apparatus of claim 1, wherein the cyclotron is made of thin, potential ferromagnetic or paramagnetic metal.

4. The apparatus of claim 1, wherein the cyclotron is a first cyclotron, the apparatus further comprising at least four more cyclotrons arranged in a stacked arrangement.

5. The apparatus of claim 1, further comprising structure configured to hold the cyclotrons together.

6. A method for capturing gases from Earth atmosphere, comprising:
orbiting at least one cyclotron in Earth orbit;
energizing the cyclotron using a radio frequency field;
passing gas ions through the cyclotron; and capturing the gas ions a dewar for capturing gases.

7. The method of claim 6, wherein the gas ions are oxygen ions.
